(19) United States
(12) Patent Application Publication
(10) Pub. No.: US 2006/0055622 A1
(43) Pub. Date: Mar. 16, 2006

(54) Antenna and radio communication terminal having antenna

(75) Inventor: Nobuya Harano, Shizuoka (JP)

Correspondence Address: Paul J. Esatto, Jr.;Scully, Scott, Murphy & Presser, 400 Garden City Plaza, Garden City, NY, 11530, US

(73) Assignee: NEC CORPORATION, TOKYO (JP)

(21) Appl. No.: 11/225,688

(22) Filed: Sep. 13, 2005

(30) Foreign Application Priority Data
Sep. 13, 2004 (JP) 265240/2004

(51) Int. Cl. H01Q 1/36

(52) U.S. Cl. 343/895

(57) ABSTRACT

An antenna in which a metal wire rod constituting an antenna element and a metal plate as an element to be linked to a feeding point can be securely connected with high electric and mechanical connection reliability and a radio communication terminal including this antenna. The metal wire rod includes an elastic part having shape elasticity and an antenna element having the desired antenna characteristics. The elastic part of the metal wire rod is press-held by bent parts of the metal plate to be shrunk in its radius direction, to accomplish a stable electric and mechanical connection between the metal wire rod and the metal plate.

### BACKGROUND OF THE INVENTION

1. Field of the Invention

The present invention relates to an antenna composed of a metal wire rod and a metal plate connected to each other and a radio communication terminal including the antenna.

2. Description of Related Art

Conventionally, an antenna has been produced by connecting a metal wire rod constituting an antenna element and a metal plate as an element to be linked to a feeding point in various manners.

In a first conventional method, as shown in FIG. 1, one part of a metal wire rod 1 is flatted by forging or the like to form a flat part 101 and the flat part 101 is connected to a metal plate 2 mechanically and electrically by welding or brazing.

In this case, when the metal wire rod 1 is thin, the flat part 101 cannot be enlarged and hence the connection force by welding or brazing becomes weak with low connection reliability. For instance, when a phosphor bronze metal wire rod 0.15 mm in diameter and a phosphor bronze metal plate 0.2 mm in thickness are used, despite phosphor bronze's characteristic suitable for welding, the diameter of the metal wire rod 1 is too thin and the connection to the metal plate 2 by welding is very difficult. If the metal wire rod 1 is welded to the metal plate 2, the welded area is small and its mechanical strength can be lowered. As a result, long time connection reliability cannot be ensured.

Furthermore, this working requires a high level technique and a producing cost of the antenna becomes high.

In a second conventional method, as shown in FIG. 2, a metal plate 2 is provided with a clamp part 102 for clamping or holding a metal wire rod 1. In this instance, when the metal wire rod 1 is thin or the metal plate 2 is thin, a sufficient force for clamping or holding the metal wire rod 1 cannot be obtained for the clamp part 102 and, when the clamping condition is loosened, a contact between the two members possibly becomes incomplete.

In a third conventional method, as shown in FIG. 3, a metal plate 2 is formed with a slit and by passing a metal wire rod 1 through the slit, the metal wire rod 1 is held to the metal plate 2. In this case, the clamping force is improved compared with the second conventional method descried above. However, the clamping condition is loosened by changes over time and thus connection reliability cannot be kept in the long term.

In the prior art, some technique for connecting a metal wire rod and a metal plate for antennas has been developed, as disclosed in patent documents such as “ANTENNA” a first document; Japanese Patent Application Laid-Open No. 2002-204115, “INTEGRALLY-MOLDED ANTENNA STRUCTURE” a second document; Japanese Patent Application Laid-Open No. 2002-368527, “ANTENNA FOR RADIO MOBILE DEVICES, ITS PRODUCING METHOD AND FEEDING STRUCTURE OF ANTENNA” a third document; Japanese Patent Application Laid-Open No. Hei 11-205017, and “FOUR-WIRE WOUND HELICAL ANTENNA” a fourth document; Japanese Patent Application Laid-Open No. 2000-223932.

In the first document, one end part of a metal wire rod constitutes a coil-shaped antenna element and the other end part is formed with a wound part of at least one turn. The wound part is press-fitted in a circular groove cut in an outer periphery of a cylindrical conductive sleeve to mount the coil antenna element to the conductive sleeve.

In this case, the wound part is inevitably formed perpendicular to an axis of the coil antenna element. That is, when the wound part is made in parallel with the axis of the coil antenna, the wound part is turned along the circular groove of the conductive sleeve and hence the antenna element cannot be fixed to the conductive sleeve. In other words, this type of structure can be hardly thin-shaped.

Further, when a diameter of a metal wire rod is very thin, the wound part with not more than one turn cannot impart a sufficient resilient or elastic force for mounting the antenna element to the conductive sleeve.

In the second document, an antenna element of a metal wire rod is connected to a conductive member and the connected portion is covered by soft resin in order to reinforce the connection.

In this case, although the connected portion between the antenna element and the conductive member is reinforced by the soft resin, no consideration is given to improve reliability of the connection between the antenna element and the conductive member. Hence, the same problem as the conventional methods arises. That is, the metal wire rod cannot be securely fixed to the metal plate.

In the third document, a resin is filled within a coil element to form an integral resin molding including the coil and the integral resin molding is covered by a cap to produce a helical antenna element unit in the form of a capped resin molding. The capped resin molding is mounted to a case body.

In this case, the coil element of a metal wire rod is connected to a feeding member in a similar manner with the conventional methods. That is, the metal wire rod is simply clamped by two metal plates. As a result, similar to the conventional methods described above, reliability of an electric connection and a mechanical connection is low.

In the fourth document, two coaxial cables and two metal wires are helically wound on an upright grooved cylinder along its helical grooves. Two central conductors of the two coaxial cables are connected to the respective two metal wires in a feeding point part positioned at the top end of the upright cylinder and two feeding points are separated from each other by an insulator. The two central conductors of the two coaxial cables are connected to respective two matching circuits. At the lower end of the upright cylinder, two outer conductors of the two coaxial cables and the two metal wires are all connected to a ground surface of a substrate via a metal plate.

In this case, when being wound on the upright cylinder, the coaxial cables and the metal wires are fitted in the helical grooves of the upright cylinder to improve the strength of the antenna element itself. However, how to connect the two central conductors of the two coaxial cables to the two matching circuits and how to connect the outer conductors of the two coaxial cables and the two metal wires to the metal plate are not disclosed. Hence, the reliability problem of the connection between the metal wire rod and the metal plate in the conventional methods cannot be solved.

As described above, in conventional antennas, a metal wire rod constituting an antenna element and a metal plate as an element to be linked to a feeding point cannot be connected with high electric and mechanical reliability.

### SUMMARY OF THE INVENTION

It is therefore an object of the present invention to provide an antenna in view of the aforementioned problems of the prior art, which is capable of connecting a metal wire rod constituting an antenna element and a metal plate as an element to be linked to a feeding point with high electric and mechanical reliability.

It is another object of the present invention to provide a radio communication terminal including an antenna which is capable of connecting a metal wire rod constituting an antenna element and a metal plate as an element to be linked to a feeding point with high electric and mechanical reliability.

In accordance with one aspect of the present invention, there is provided an antenna including a metal wire rod and a metal plate connected to each other, the metal wire rod comprising an elastic part having shape elasticity and an antenna element having specified antenna characteristics, the metal plate comprising a pair of bent parts, the bent parts press-holding the elastic part to shrink along a row of the bent parts.

In an antenna, the elastic part is formed in one end part of the metal wire rod or the elastic part is formed in a central part of the metal wire rod.

In an antenna, the metal plate having a rough T-shape includes a pair of side parts projecting in its both side directions on its one end part and the side parts are bent to form the bent parts.

In accordance with another aspect of the present invention, there is provided an antenna including at least two metal wire rods and at lease two metal plates connected to one another, each metal wire rod comprising at least one elastic part having shape elasticity and an antenna element having specified antenna characteristics, each metal plate comprising at least one pair of bent parts, each pair of bent parts press-holding the elastic part to shrink along a row of the bent parts to connect one metal wire rod and one metal plate.

In an antenna, one metal plate having a rough H-shape includes two pairs of side parts projecting in its both side directions on its both end parts and the side parts are bent to form the bent parts, each pair of bent parts press-holding the elastic part of each metal wire rod to connect two metal wire rods via the metal plate.

In an antenna, one metal plate having a rough T-shape includes a pair of side parts projecting in its both side directions on its one end part and the side parts are bent to form the bent parts for press-holding the elastic part of the metal wire rod to connect the metal wire rod and the metal plate.

In an antenna, a width of the elastic part of the metal wire rod is larger than an interval of each pair of bent parts.

In an antenna, one part of the metal wire rod can be bent in a coil shape to form the elastic part. One part of the metal wire rod can be bent in a waveform shape to form the elastic part. One part of the metal wire rod can be further bent in an arc shape to form the elastic part.

In an antenna, the elastic part is press-held by the bent parts to shrink also in its thickness direction.

In an antenna, the elastic part press-held by the bent parts is covered by resin material.

In accordance with a further aspect of the present invention, there is provided a radio communication terminal including an antenna including a metal wire rod and a metal plate connected to each other for carrying out radio communications via the antenna, the metal wire rod comprising an elastic part having shape elasticity and an antenna element having specified antenna characteristics, the metal plate comprising a pair of bent parts, the bent parts press-holding the elastic part to shrink along a row of the bent parts.

In accordance with still another aspect of the present invention, there is provided a radio communication terminal including an antenna including at least two metal wire rods and at lease two metal plates connected to one another for carrying out radio communications via the antenna, each metal wire rod comprising at least one elastic part having shape elasticity and an antenna element having specified antenna characteristics, each metal plate comprising at least one pair of bent parts, each pair of bent parts press-holding the elastic part to shrink along a row of the bent parts to connect one metal wire rod and one metal plate.

According to the present invention, an antenna in which a metal wire rod constituting an antenna element and a metal plate as an element to be linked to a feeding point can be securely connected with high electric and mechanical connection reliability and a radio communication terminal including this antenna can be provided.

### BRIEF DESCRIPTION OF THE DRAWINGS

The objects, features and advantages of the present invention will become more apparent from the consideration of the following detailed description, taken in conjunction with the accompanying drawings, in which:

FIG. 1 is a perspective view showing a connection of a metal wire rod and a metal plate of a first conventional antenna;

FIG. 2 is a perspective view showing a connection of a metal wire rod and a metal plate of a second conventional antenna;

FIG. 3 is a perspective view showing a connection of a metal wire rod and a metal plate of a third conventional antenna;

FIG. 4 is a perspective view of an antenna according to a first embodiment of the present invention;

FIG. 5 is an exploded plan view showing a metal wire rod and a metal plate of the antenna shown in FIG. 4 before the metal wire rod and the metal plate are connected;

FIG. 6 is an elevational view showing an elastic part of the metal wire rod, press-held by bent parts of the metal plate, as shown in FIG. 4;

FIG. 7 is an exploded plan view showing a metal wire rod and a metal plate of an antenna according to a second embodiment of the present invention before the metal wire rod and the metal plate are connected;

FIG. 8 is an exploded plan view showing a metal wire rod and a metal plate of an antenna according to a third embodiment of the present invention before the metal wire rod and the metal plate are connected;

FIG. 9 is an exploded plan view showing a metal wire rod and a metal plate of an antenna according to a fourth embodiment of the present invention before the metal wire rod and the metal plate are connected;

FIGS. 10a, 10b and 10c show an elastic part of a metal wire rod used in an antenna according to a fifth embodiment of the present invention, FIG. 10a is a top plan view of the elastic part before connected, FIG. 10b an elevational view of FIG. 10a before connected, and FIG. 10c an elevational view of the elastic part after connected;

FIG. 11 is a perspective view of an antenna according to a sixth embodiment of the present invention;

FIG. 12a is a top plan view and FIG. 12b is an elevational view, showing an antenna according to a seventh embodiment of the present invention;

FIG. 13a is an elevational view showing a case body for an antenna of the seventh embodiment; FIG. 13b is an elevational view of an antenna element not contained in the case body shown in FIG. 13a; and FIG. 13c is an elevational view of an antenna according to the seventh embodiment, contained in the case body according to the seventh embodiment; and

FIG. 14 is a top plan view of an antenna according to an eighth embodiment of the present invention.

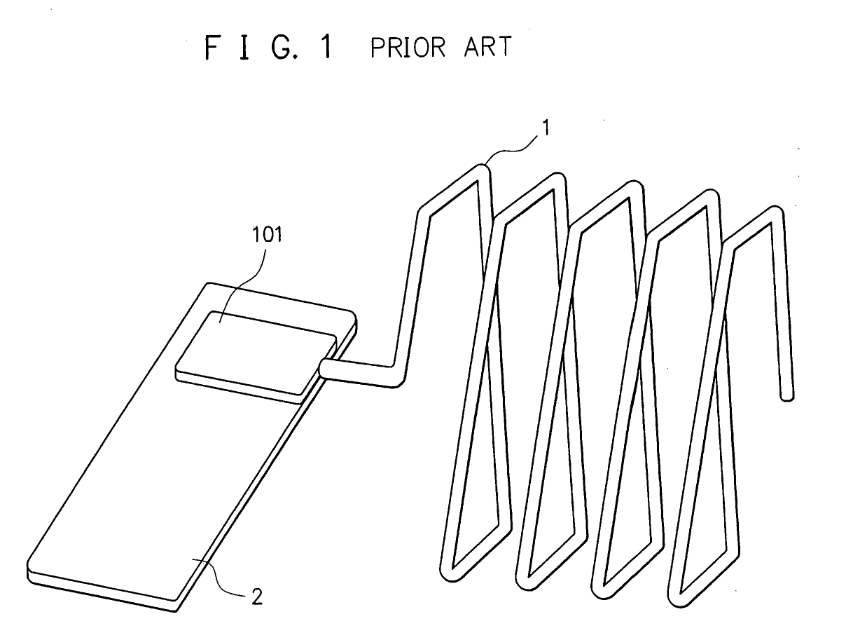

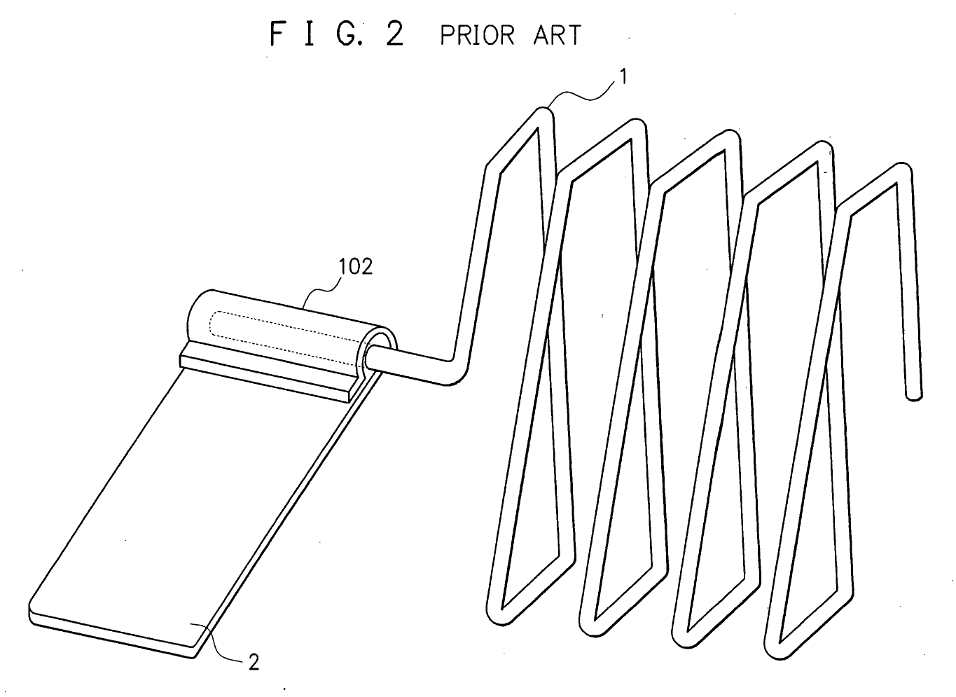

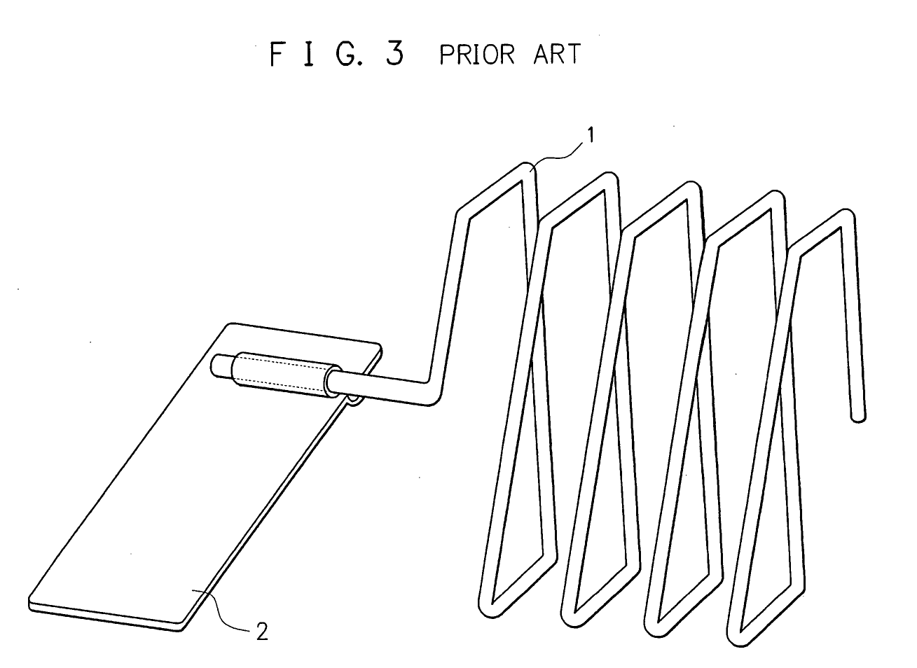

### DESCRIPTION OF THE PREFERRED EMBODIMENTS

The present invention will now be described in detail with reference to its preferred embodiments in connection with the accompanying drawings.

In general, metal materials have high rigidity and their variations due to volume elasticity are quite small. Hence, when a metal wire rod is held or clamped by metal plates in the same manner as the aforementioned second or third conventional method, in fact, plastic deformation occurs so that the metal plates extend and no clamping force acts on the metal wire rod.

According to the present invention, by bending one part of a metal wire rod, a resilient or elastic part having a shape such as an arc, a circle or ellipse of at least one turn, a waveform, a meander and the like is formed and this elastic part is press-held or -clamped by metal plates. That is, one part of a metal wire rod is bent to form an elastic part having shape elasticity. While the elastic part of the metal wire rod is pressed so as to shrink in size within its elastic limit of shape elasticity, the shrunk elastic part is held or clamped by the metal plates to cause an elastic force to raise a connection force between the metal wire rod and the metal plate. This is why, when the metal plates extend owing to their plastic deformation, the shrunk elastic part of the metal wire rod extends in conformity and the clamping force of the metal plates is maintained. Hence, the metal wire rod can be securely connected to the metal plates with high reliability of the electric and mechanical connection.

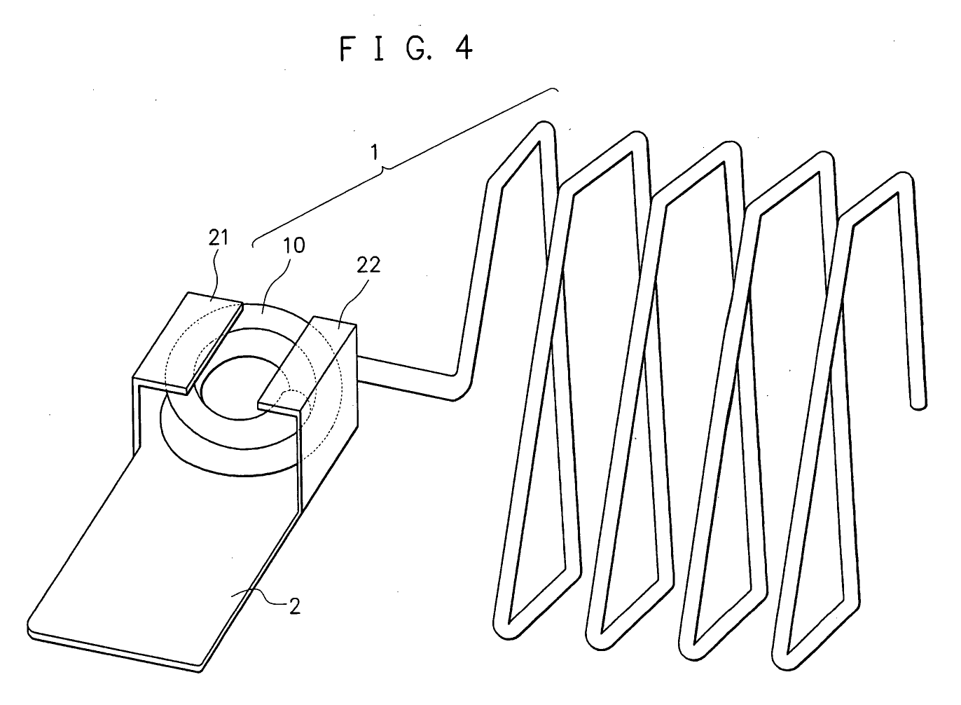

There is shown in FIG. 4 an antenna according to a first embodiment of the present invention.

As shown in FIG. 4, one end part of a metal wire rod 1 is bent in a coil shape to form an elastic part 10 and the other end part is also bent in a proper shape to form an antenna element 3 having the desired antenna characteristics. A metal plate 2 is linked to a feeding point such as a printed substrate or a metal contact point. The metal plate 2 is provided with a pair of L-shaped bent parts 21 and 22 vertically extending in parallel with a certain space between them. The elastic part 10 of the metal wire rod 1 is held or clamped by the bent parts 21 and 22 of the metal plate 2.

In this embodiment, the bent parts 21 and 22 of the metal plate 2 press-hold the elastic part 10 as if the elastic part 10 were squeezed along a row of the bent parts to cause an elastic force. Hence, the elastic part 10 of the metal wire rod 1 is press-contacted with the bent parts 21 and 22 of the metal plate 2, and an electric and mechanical connection between the elastic part 10 of the metal wire rod 1 and the bent parts 21 and 22 of the metal plate 2 can be exactly performed.

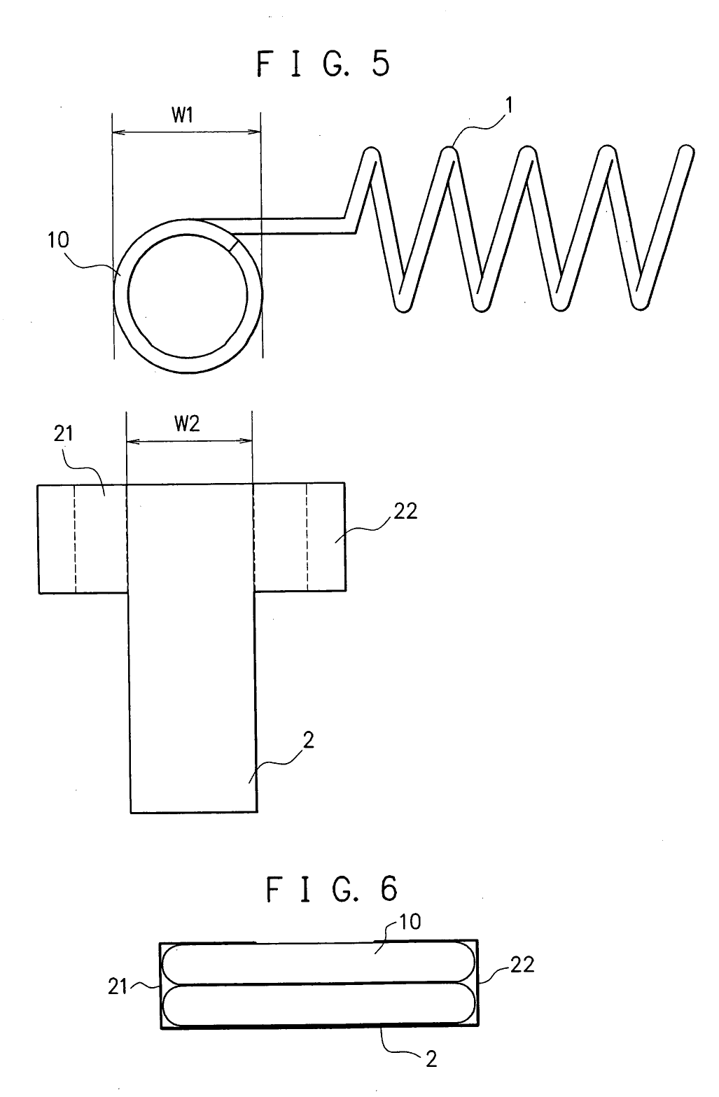

FIG. 5 is an exploded plan view of a metal wire rod 1 and a metal plate 2 of the antenna shown in FIG. 4 before the metal wire rod 1 and the metal plate 2 are connected. As shown in FIG. 5, the metal plate 2 having a rough T-shape includes a pair of bent parts 21 and 22 projecting in its both side directions. The bent parts 21 and 22 of the metal plate 2 are not bent yet and are to be bent along broken lines to hold or clamp the elastic part 10 of the metal wire rod 1, as shown in FIG. 4. Now, assuming that a diameter of the coil of the elastic part 10 of the metal wire rod 1 before connected is W1 and an interval between the bent parts 21 and 22 of the metal plate 2 is W2, then W1>W2. Hence, when the elastic part 10 of the metal wire rod 1 is held or clamped by the bent parts 21 and 22 of the metal plate 2, the elastic part 10 is pressed to shrink in size from W1 to W2 to cause an elastic force. Therefore, the elastic part 10 of the metal wire rod 1 is press-contacted with the bent parts 21 and 22 of the metal plate 2 to accomplish a stable electric and mechanical connection between the metal wire rod 1 and the metal plate 2.

FIG. 6 is an elevational view showing the elastic part 10 (some two turns of coil) press-held or -clamped by the bent parts 21 and 22 of the metal plate 2, as shown in FIG. 4.

In this embodiment, as described above, one part of the metal wire rod 1 is bent to form the elastic part 10 having the shape elasticity and the elastic part 10 of the metal wire rod 1 is press-held by the bent parts 21 and 22 of the metal plate 2. Hence, the electric and mechanical connection between the metal wire rod 1 and the metal plate 2 can be securely carried out with high connection reliability.

Furthermore, a connection working can be readily conducted compared with a working using welding or brazing to improve workability.

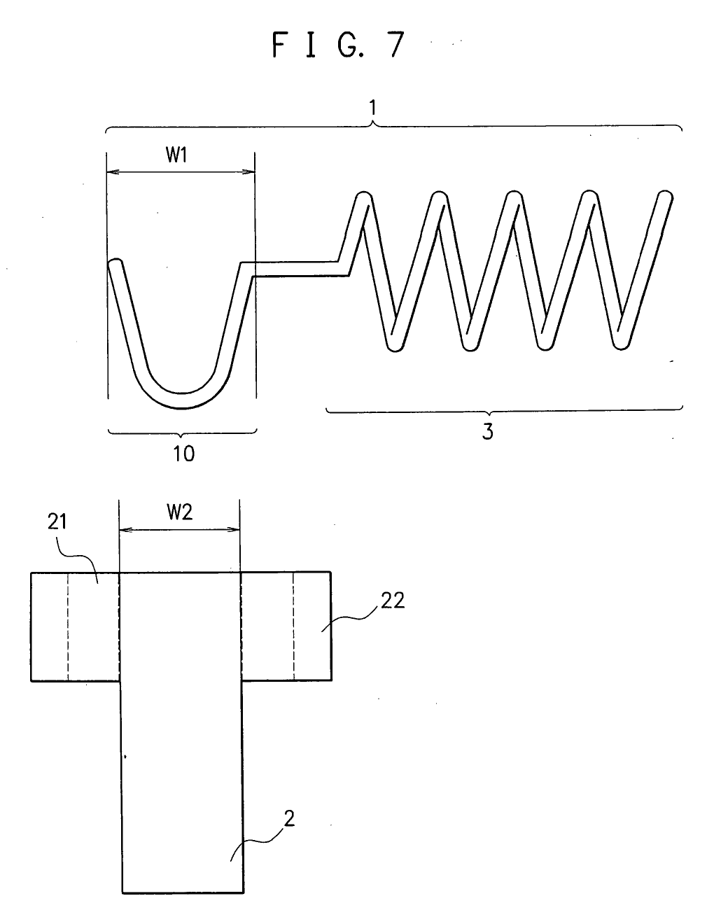

There is shown in FIG. 7 a metal wire rod 1 and a metal plate 2 of an antenna according to a second embodiment of the present invention before the metal wire rod 1 and the metal plate 2 are connected.

In this embodiment, one end part of the metal wire rod 1 is bent in an arc shape (a circular arc shape, an elliptic arc shape or a sine curve shape) to form an elastic part 10 and the other end part is also bent in a proper shape to form an antenna element 3 having the desired antenna characteristics. The metal plate 2 is connected to a feeding point such as a printed substrate or a metal contact point. As shown in FIG. 7, the metal plate 2 having a rough T-shape includes a pair of bent parts 21 and 22 projecting in its both side directions. The bent parts 21 and 22 of the metal plate 2 are not bent yet and are to be bent along broken lines.

Now, assuming that a width of the arc of the elastic part 10 of the metal wire rod 1 before connected is W1 and an interval between the bent parts 21 and 22 of the metal plate 2 is W2, then W1>W2. Hence, when the elastic part 10 of the metal wire rod 1 is held or clamped by the bent parts 21 and 22 of the metal plate 2, the elastic part 10 is pressed to shrink in size from W1 to W2 to cause an elastic force. Therefore, the elastic part 10 of the metal wire rod 1 is press-contacted with the bent parts 21 and 22 of the metal plate 2 to perform a stable electric and mechanical connection between the metal wire rod 1 and the metal plate 2.

In this embodiment, in the case of the metal wire rod 1 having high rigidity, even when the elastic part 10 of the metal wire rod 1 is formed in the arc shape, a sufficient contact pressure can be caused for ensuring reliability of an electric and mechanical connection between the metal wire rod 1 and the metal plate 2.

As the elastic part an arc shape can be readily formed rather than a coil shape. Hence, in this embodiment, an antenna can be produced at lower cost than one produced according to the first embodiment described above.

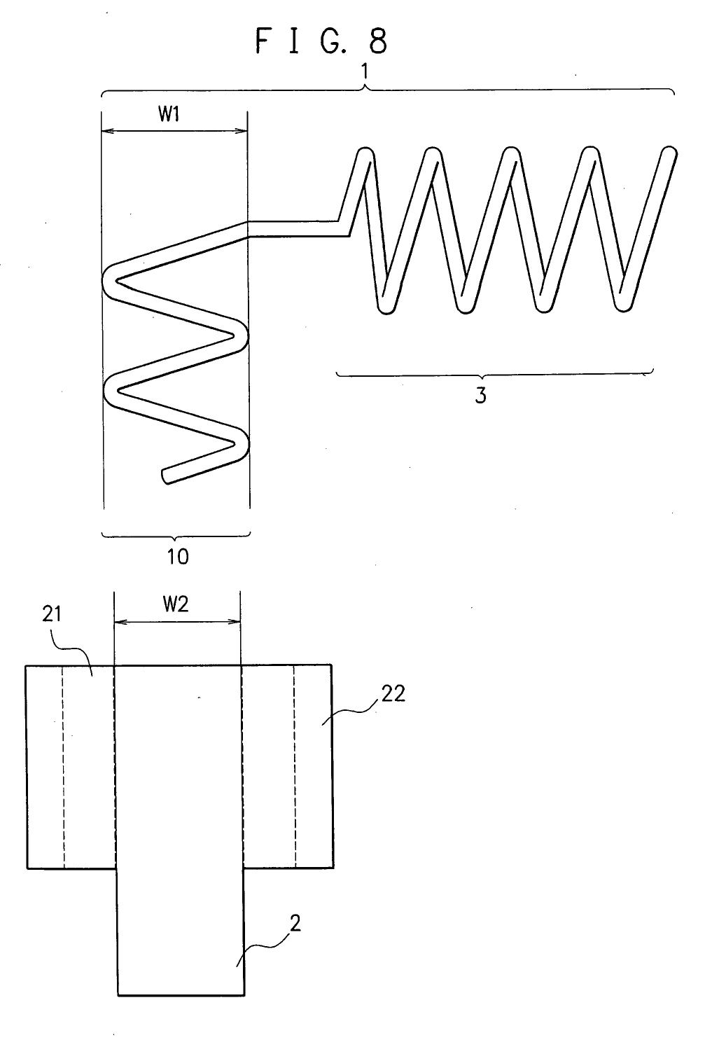

There is shown in FIG. 8 a metal wire rod 1 and a metal plate 2 of an antenna according to a third embodiment of the present invention before the metal wire rod 1 and the metal plate 2 are connected.

In this embodiment, one end part of the metal wire rod 1 is bent in a waveform shape to form an elastic part 10 and the other end part is also bent in a proper shape to form an antenna element 3 having the desired antenna characteristics. The metal plate 2 is connected to a feeding point such as a printed substrate or a metal contact point. The metal plate 2 having a rough T-shape includes a pair of bent parts 21 and 22 projecting in its both side directions. The bent parts 21 and 22 of the metal plate 2 are not bent yet and are to be bent along broken lines.

Now, assuming that a width of the elastic part 10 of the metal wire rod 1 before connected is W1 and an interval between the bent parts 21 and 22 of the metal plate 2 is W2, then W1>W2. Hence, when the elastic part 10 of the metal wire rod 1 is held or clamped by the bent parts 21 and 22 of the metal plate 2, the elastic part 10 is pressed to shrink in size from W1 to W2 to cause elastic force. Therefore, the elastic part 10 of the metal wire rod 1 is press-contacted with the bent parts 21 and 22 of the metal plate 2 to accomplish a stable electric and mechanical connection between the metal wire rod 1 and the metal plate 2.

In the above-described first embodiment, since one end part of the metal wire rod 1 is bent in the coil shape to form the elastic part 10, a turn number of the coil is increased for obtaining a strong elastic force with the result of a thickened elastic part 10. In this embodiment, on the other hand, since one end part of the metal wire rod 1 is bent in the waveform shape to form the elastic part 10, the thickness of the elastic part 10 is the same as the diameter of the metal wire rod 1. Restrictions for implementation can be reduced in comparison with an antenna produced according to the first embodiment and thus a terminal using the antenna provided by this embodiment can be thin-shaped.

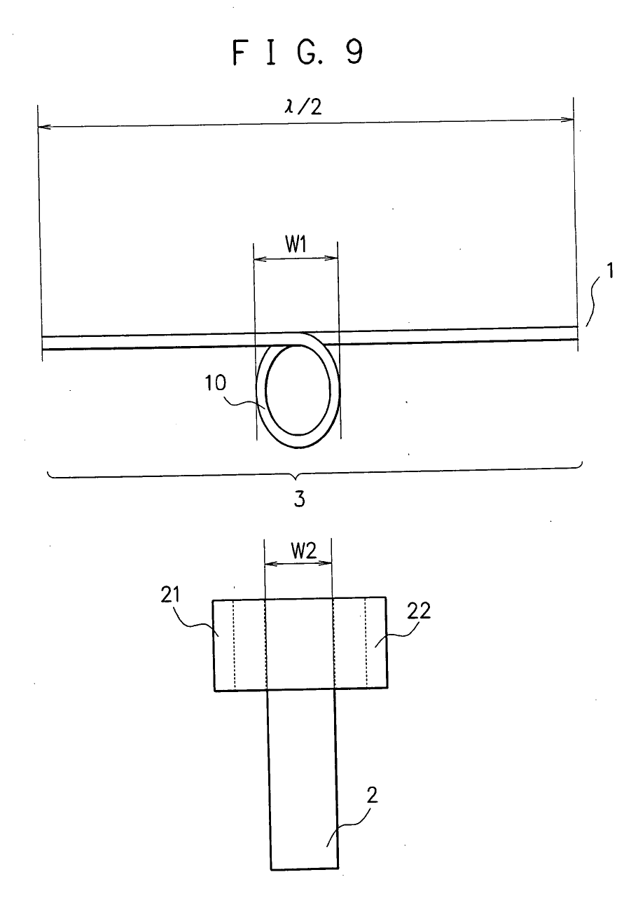

There is shown in FIG. 9 a metal wire rod 1 and a metal plate 2 of an antenna according to a fourth embodiment of the present invention before the metal wire rod 1 and the metal plate 2 are connected.

In this embodiment, a central part of the metal wire rod 1 is bent in a loop shape that serves as an elastic part 10. The whole length of the metal wire rod 1 is λ/2, a half of a wavelength λ of an electromagnetic wave employed for transmitting and receiving. The metal plate 2 is connected to a feeding point such as a printed substrate or a metal contact point. The metal plate 2 having a rough T-shape includes a pair of bent parts 21 and 22 projecting in its both side directions. The bent parts 21 and 22 of the metal plate 2 are not bent yet and are to be bent along broken lines.

Now, assuming that a width of the elastic part 10 of the metal wire rod 1 before connected is W1 and an interval between the bent parts 21 and 22 of the metal plate 2 is W2, then W1>W2. Hence, when the elastic part 10 of the metal wire rod 1 is held or clamped by the bent parts 21 and 22 of the metal plate 2, the elastic part 10 is pressed to shrink from W1 to W2 to cause elastic force. Therefore, the elastic part 10 of the metal wire rod 1 is press-contacted with the bent parts 21 and 22 of the metal plate 2 to accomplish a stable electric and mechanical connection between the metal wire rod 1 and the metal plate 2.

In an antenna produced according to this embodiment, antenna impedance can be adjusted by changing the position of the elastic part 10 of the metal wire rod 1.

In this embodiment, although the length of an antenna element 3 is determined to be half the wavelength of the electromagnetic wave used for transmitting and receiving, it is not restricted to this value and λ/4, λ/8, 3 λ/8 and the like can be used.

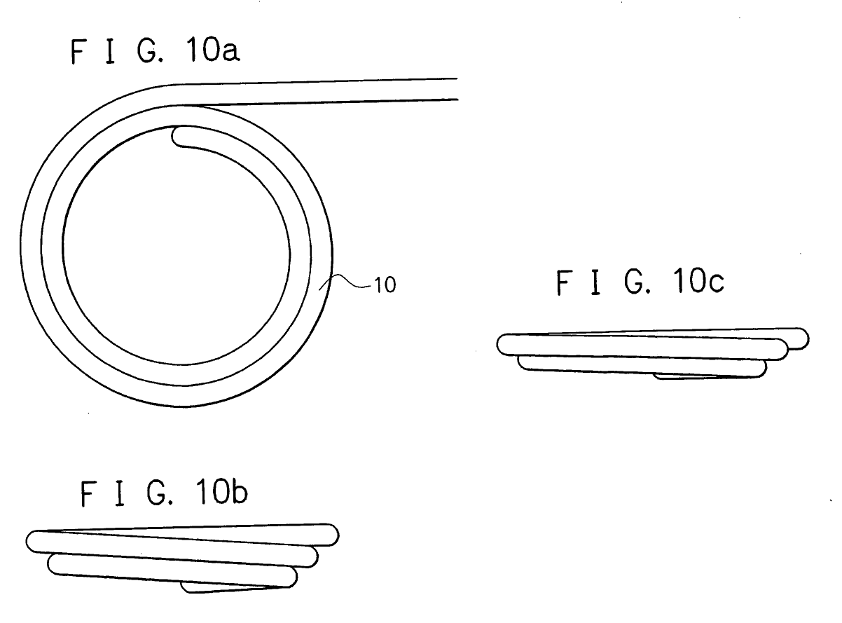

There is shown in FIG. 10a to FIG. 10c an elastic part 10 of a metal wire rod 1 used in an antenna according to a fifth embodiment of the present invention. One end part of the metal wire rod 1 is bent inside in an eddy shape to form an elastic part 10 before connected, as shown in FIG. 10a and FIG. 10b. In this embodiment, the other parts of the antenna have the same constructions as those of the first embodiment described above and their detailed description can be omitted for brevity.

When the metal wire rod 1 and the metal plate 2 are connected, the elastic part 10 of the metal wire rod 1 is press-held by the bent parts 21 and 22 of the metal plate 2 in the same manner as the above-described embodiments. On this occasion, the elastic part 10 of the metal wire rod 1 is pressed not only in a width direction but also a thickness direction so as to shrink in size, as shown in FIG. 10c.

In this embodiment, the metal wire rod 1 is contacted with the metal plate 2 by means of the elastic forces caused in both the width and thickness directions by the shrunk elastic part 10.

In an antenna produced according to this embodiment, since the elastic part 10 of the metal wire rod 1 is press-contacted with the metal plate 2 by the elastic forces in the two directions such as the width and thickness directions, a more stable electric and mechanical connection between the metal wire rod 1 and the metal plate 2 can be exactly carried out compared with the aforementioned previous embodiments.

In the case of the elastic part 10 having the arc shape or the waveform shape, such a shape can also be bent in a three-dimensional manner, for instance, in a vertical direction so as to form an arc, to cause the elastic force in two directions.

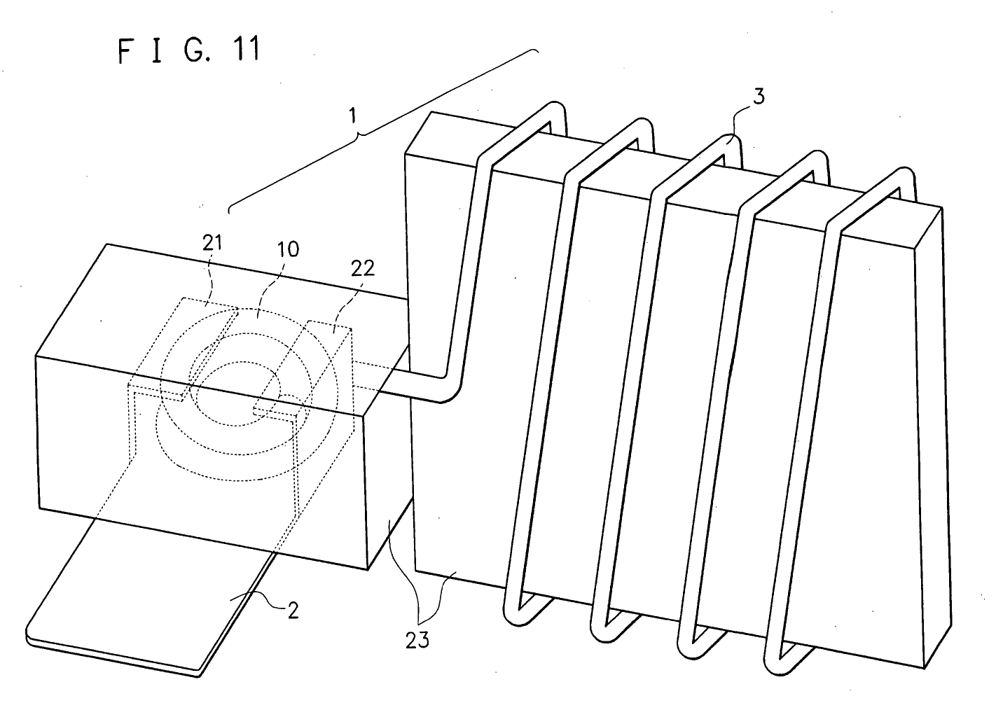

There is shown in FIG. 11 an antenna according to a sixth embodiment of the present invention.

In this embodiment, an antenna structure is the same as the first embodiment described above. One end part of a metal wire rod 1 is bent in a coil shape to form an elastic part 10 and the other end part is also bent in a proper shape to form an antenna element 3 having the desired antenna characteristics. The elastic part 10 of the metal wire rod 1 is press-held by bent parts 21 and 22 of the metal plate 2 so as to be shrunk.

In this embodiment, the metal wire rod 1 and the metal plate 2 are integrally molded by a resin material 23. As to the resin material 23, engineering plastics having a high mechanical strength such as ABS (acrylonitrile butadiene styrene) resin and the like can be preferably employed.

In the case where the metal wire rod 1 and the metal plate 2 have small mechanical strength, for example, the metal wire rod 1 is 0.2 mm in diameter and the metal plate 2 is 0.2 mm in thickness, when external forces act on the metal wire rod 1 and the metal plate 2, they can be readily deformed. The deformations of the metal wire rod 1 and the metal plate 2 cause a failure of an electric connection between them. In addition, when the antenna element 3 is deformed, the desired antenna characteristics cannot be obtained.

In an antenna produced according to this embodiment, the metal wire rod 1 and the metal plate 2 are integrally molded by using the resin material 23 and the metal wire rod 1 and the metal plate 2 become strong against the external forces to prevent their deformations.

Furthermore, since the connection part between the metal wire rod 1 and the metal plate 2 is also reinforced by the resin material 23, the electric connection between the metal wire rod 1 and the metal plate 2 can be securely performed.

In this embodiment, although the elastic part 10 having the coil shape and the metal plate 2 are integrally molded by using the resin material 23, the shape of the elastic part 10 is not restricted to the coil.

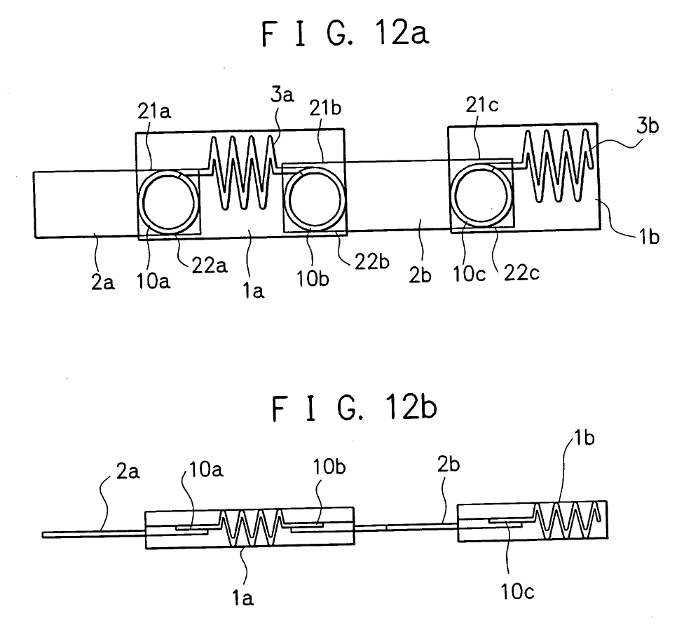

FIG. 12a is a top plan view and FIG. 12b is an elevational view, showing an antenna according to a seventh embodiment of the present invention.

In this embodiment, a first metal wire rod 1a and a second metal wire rod 1b are coupled with each other via a second metal plate 2b along a straight line.

Both end parts of the first metal wire rod 1a are bent in coil shapes to form first and second elastic parts 10a and 10b and a central part of the first metal wire rod 1a is also bent in a proper shape to form a first antenna element 3a having the desired antenna characteristics. A first metal plate 2a is connected to a feeding point such as a printed substrate or a metal contact point. The first metal plate 2a having a rough T-shape includes a pair of first bent parts 21a and 22a projecting in its both side directions on its one end portion and the first bent parts 21a and 22a of the first metal plate 2a are to be bent upwards in the same manner as the first embodiment.

One end part of the second metal wire rod 1b is bent in a coil shape to form a third elastic part 10c and the other end part is also bent in a proper shape to form an antenna element 3b having the desired antenna characteristics. The second metal plate 2b having a rough H-shape includes two pairs of second bent parts 21b and 22b and third bent parts 21c and 22c, both projecting in its both side directions on its both end portions. The second bent parts 21b and 22b and the third bent parts 21c and 22c are to be bent upwards in the same manner as described above.

In this embodiment, the first bent parts 21a and 22a of the first metal plate 2a press-hold the first elastic part 10a so as to shrink in its radius direction to cause an elastic force. Hence, the elastic part 10a of the first metal wire rod 1a is press-contacted with the first bent parts 21a and 22a of the first metal plate 2a and an electric and mechanical connection between the first metal wire rod 1a and the first metal plate 2a can be exactly performed.

The second bent parts 21b and 22b of the second metal plate 2b press-hold the second elastic part 10b so as to be shrunk or diminished in its radius direction to cause an elastic force. Hence, the second elastic part 10b of the first metal wire rod 1a is press-contacted with the second bent parts 21b and 22b of the second metal plate 2b and an electric and mechanical connection between the first metal wire rod 1a and the second metal plate 2b can be properly carried out.

The third bent parts 21c and 22c of the second metal plate 2b press-hold the third elastic part 10c so as to shrink in its radius direction to cause elastic force. Hence, the third elastic part 10c of the second metal wire rod 1b is press-contacted with the third bent parts 21c and 22c of the second metal plate 2b and an electric and mechanical connection between the second metal wire rod 1b and the second metal plate 2b can be properly conducted.

Conventionally, as an antenna of a radio communication terminal, an exposed type outside a case body (a type where an antenna is drawn from a case body when the antenna is used) has been mainly adopted. In recent years, an antenna type housed within a case body has become a mainstream.

When an antenna is mounted to be exposed outside a case body, not many limitations for mounting an antenna element are required. However, in the case of an antenna contained within a case body, the limitations for mounting increase.

In general, when a metal wire rod is bent to form an antenna element, a thickness of the antenna element becomes larger than a diameter of the metal wire rod. Accordingly, when an antenna element must elongate its length for obtaining the desired antenna characteristics, a metal wire rod 1 sometimes cannot be extended to a necessary length in a high mounting density device such as a small-sized radio device or the like under constraints upon mounting.

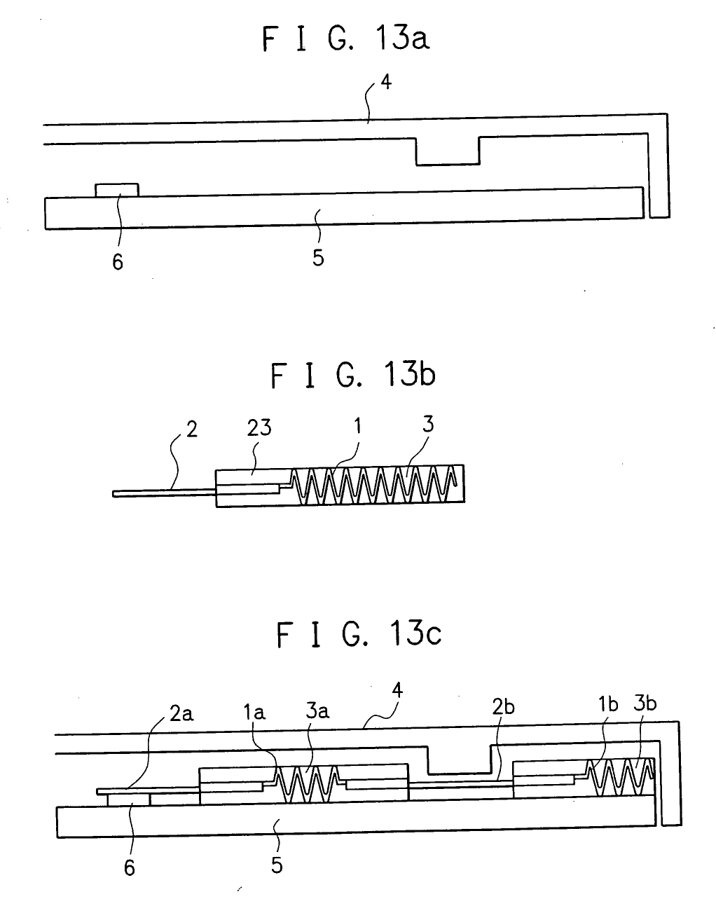

For instance, in the case of a radio communication terminal having an internal mounting space within a case body 4, as shown in FIG. 13a, an antenna shown in FIG. 13b cannot be contained within the case body 4.

In such a case, an antenna structure according to this embodiment can be contained in the case body 4. That is, as shown in FIG. 13c, a plurality of metal wire rods 1a and 1b having antenna elements 3a and 3b are coupled by a metal plate 2b to meet the desired antenna characteristics in their coupled conditions.

In this case, since metal plates 2a and 2b can be installed and fixed to a substrate 5 or a feeding point 6 in the narrow space of the case body 4 where an antenna element shown in FIG. 13b cannot be formed, in an antenna structure according to this embodiment, as shown in FIG. 13c, the narrow space can be effectively utilized to obtain the desired antenna characteristics.

In this embodiment, although two metal wire rods are coupled to form an antenna element, more than three metal wire rods can be connected.

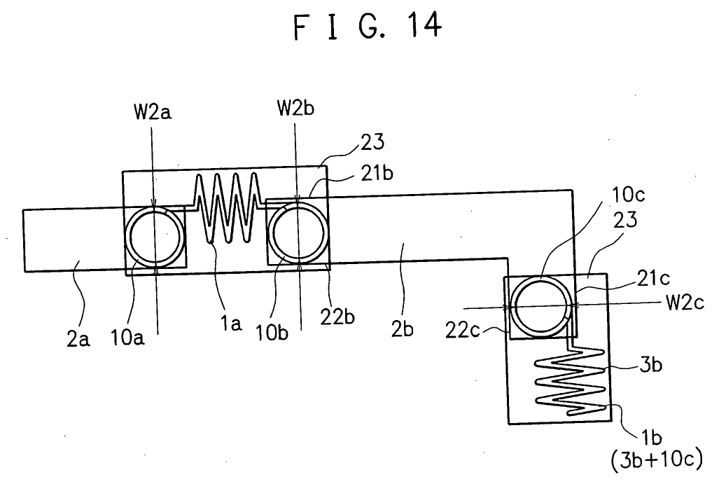

There is shown in FIG. 14 an antenna according to an eighth embodiment of the present invention.

In this embodiment, a first metal wire rod 1a and a second metal wire rod 1b are coupled with each other via a second metal plate 2b in an L-shaped line in the same manner as the seventh embodiment shown in FIG. 12a.

In this instance, the first metal wire rod 1a, the second metal wire rod 1b and a first metal plate 2a have the same constructions as those of the seventh embodiment and thus their detailed descriptions can be omitted for brevity. The second metal plate 2b having a rough L-shape includes two pairs of second bent parts 21b and 22b and third bent parts 21c and 22c on its both end portions. One end part of the second metal wire rod 1b is bent in a coil shape to form a third elastic part 10c and the other end part is also bent in a proper shape to form an antenna element 3b having the desired antenna characteristics.

Now, assuming that a diameter of the first elastic part 10a of the first metal wire rod 1a before connected is W1a and the width between the first bent parts 21a and 22a of the first metal plate 2a is W2a, then W1a>W2a.

Assuming that a diameter of the second elastic part 10b of the first metal wire rod 1a before connected is W1b and the width between the second bent parts 21b and 22b of the second metal plate 2b is W2b, then W1b>W2b.

Further, assuming that a diameter of the third elastic part 10c of the second metal wire rod 1b before connected is W1c and the width between the third bent parts 21c and 22c of the second metal plate 2b is W2c, then W1c>W2c.

In this embodiment, the first bent parts 21a and 22a of the first metal plate 2a press-hold the first elastic part 10a to shrink in its radius direction to cause an elastic force. Hence, the elastic part 10a of the first metal wire rod 1a is press-contacted with first the bent parts 21a and 22a of first the metal plate 2a and an electric and mechanical connection between the first metal wire rod 1a and the first metal plate 2a can be properly performed.

The second bent parts 21b and 22b of the second metal plate 2b press-hold the second elastic part 10b to shrink in its radius direction to cause an elastic force. Hence, the second elastic part 10b of the first metal wire rod 1a is press-contacted with the second bent parts 21b and 22b of the second metal plate 2b and an electric and mechanical connection between the first metal wire rod 1a and the second metal plate 2b can be properly carried out.

The third bent parts 21c and 22c of the second metal plate 2b press-hold the third elastic part 10c so as to be shrunk or diminished in its radius direction to cause an elastic force. Hence, the third elastic part 10c of the second metal wire rod 1b is press-contacted with the third bent parts 21c and 22c of the second metal plate 2b and an electric and mechanical connection between the second metal wire rod 1b and the second metal plate 2b can be exactly conducted.

While the present invention has been described with reference to the particular illustrative embodiments, it is not to be restricted by those embodiments but only by the appended claims. It is to be appreciated that those skilled in the art can change and modify the embodiments without departing from the scope and spirit of the present invention.

For example, when an elastic part of a metal wire rod possesses shape elasticity at least in a width direction, any different structure from those exemplified in the aforementioned preferred embodiments of the present invention may be employed. For instance, a metal wire rod can be bent at random to form an elastic part. In other words, there is no need that a metal wire rod is bent to a specific geometrical shape as described in the preferred embodiments of the present invention. In this way, various changes and modifications can be done according to the present invention.

What is claimed is:

1. An antenna including a metal wire rod and a metal plate connected to each other, the metal wire rod comprising an elastic part having shape elasticity and an antenna element having specified antenna characteristics, the metal plate comprising a pair of bent parts, the bent parts press-holding the elastic part to shrink along a row of the bent parts.

2. An antenna of claim 1, wherein the elastic part is formed in one end part of the metal wire rod.

3. An antenna of claim 1, wherein the elastic part is formed in a central part of the metal wire rod.

4. An antenna of any of claims 1 to 3, wherein the metal plate having a rough T-shape includes a pair of side parts projecting in its both side directions on its one end part and the side parts are bent to form the bent parts.

5. An antenna including at least two metal wire rods and at lease two metal plates connected to one another, each metal wire rod comprising at least one elastic part having shape elasticity and an antenna element having specified antenna characteristics, each metal plate comprising at least one pair of bent parts, each pair of bent parts press-holding the elastic part to shrink along a row of the bent parts to connect one metal wire rod and one metal plate.

6. An antenna of claim 5, wherein one metal plate having a rough H-shape includes two pairs of side parts projecting in its both side directions on its both end parts and the side parts are bent to form the bent parts, each pair of bent parts press-holding the elastic part of each metal wire rod to connect two metal wire rods via the metal plate.

7. An antenna of claim 5 or 6, wherein one metal plate having a rough T-shape includes a pair of side parts projecting in its both side directions on its one end part and the side parts are bent to form the bent parts for press-holding the elastic part of the metal wire rod to connect the metal wire rod and the metal plate.

8. An antenna of claim 1, wherein a width of the elastic part of the metal wire rod is larger than an interval of each pair of bent parts.

9. An antenna of claim 1, wherein one part of the metal wire rod is bent in a coil shape to form the elastic part.

10. An antenna of claim 1, wherein one part of the metal wire rod is bent in a waveform shape to form the elastic part.

11. An antenna of claim 1, wherein one part of the metal wire rod is bent in an arc shape to form the elastic part.

12. An antenna of claim 1, wherein the elastic part is press-held by the bent parts to shrink also in its thickness direction.

13. An antenna of claim 1, wherein the elastic part press-held by the bent parts is covered by resin material.

14. An antenna of claim 5, wherein a width of the elastic part of the metal wire rod is larger than an interval of each pair of bent parts.

15. An antenna of claim 5, wherein one part of the metal wire rod is bent in a coil shape to form the elastic part.

16. An antenna of claim 5, wherein one part of the metal wire rod is bent in a waveform shape to form the elastic part.

17. An antenna of claim 5, wherein one part of the metal wire rod is bent in an arc shape to form the elastic part.

18. An antenna of claim 5, wherein the elastic part is press-held by the bent parts to shrink also in its thickness direction.

19. An antenna of claim 5, wherein the elastic part press-held by the bent parts is covered by resin material.

20. A radio communication terminal including an antenna including a metal wire rod and a metal plate connected to each other for carrying out radio communications via the antenna, the metal wire rod comprising an elastic part having shape elasticity and an antenna element having specified antenna characteristics, the metal plate comprising a pair of bent parts, the bent parts press-holding the elastic part to shrink along a row of the bent parts.

21. A radio communication terminal of claim 20, wherein the elastic part is formed on one end part of the metal wire rod.

22. A radio communication terminal of claim 20, wherein the elastic part is formed in a central part of the metal wire rod.

23. A radio communication terminal of any of claims 20 to 22, wherein the metal plate having a rough T-shape includes a pair of side parts projecting in its both side directions on its one end part and the side parts are bent to form the bent parts.

24. A radio communication terminal including an antenna including at least two metal wire rods and at lease two metal plates connected to one another for carrying out radio communications via the antenna, each metal wire rod comprising at least one elastic part having shape elasticity and an antenna element having specified antenna characteristics, each metal plate comprising at least one pair of bent parts, each pair of bent parts press-holding the elastic part to shrink along a row of the bent parts to connect one metal wire rod and one metal plate.

25. A radio communication terminal of claim 24, wherein one metal plate having a rough H-shape includes two pairs of side parts projecting in its both side directions on its both end parts and the side parts are bent to form the bent parts, each pair of bent parts press-holding the elastic part of each metal wire rod to connect two metal wire rods via the metal plate.

26. A radio communication terminal of claim 24 or 25, wherein one metal plate having a rough T-shape includes a pair of side parts projecting in its both side directions on its one end part and the side parts are bent to form the bent parts for press-holding the elastic part of the metal wire rod to connect the metal wire rod and the metal plate.

27. A radio communication terminal of claim 20, wherein a width of the elastic part of the metal wire rod is larger than an interval of each pair of bent parts.

28. A radio communication terminal of claim 20, wherein one part of the metal wire rod is bent in a coil shape to form the elastic part.

29. A radio communication terminal of claim 20, wherein one part of the metal wire rod is bent in a waveform shape to form the elastic part.

30. A radio communication terminal of claim 20, wherein one part of the metal wire rod is bent in an arc shape to form the elastic part.

31. A radio communication terminal of claim 20, wherein the elastic part is press-held by the bent parts to shrink also in its thickness direction.

32. A radio communication terminal of claim 20, wherein the elastic part press-held by the bent parts is covered by resin material.

33. A radio communication terminal of claim 24, wherein a width of the elastic part of the metal wire rod is larger than an interval of each pair of bent parts.

34. A radio communication terminal of claim 24, wherein one part of the metal wire rod is bent in a coil shape to form the elastic part.

35. A radio communication terminal of claim 24, wherein one part of the metal wire rod is bent in a waveform shape to form the elastic part.

36. A radio communication terminal of claim 24, wherein one part of the metal wire rod is bent in an arc shape to form the elastic part.

37. A radio communication terminal of claim 24, wherein the elastic part is press-held by the bent parts to shrink also in its thickness direction.

38. A radio communication terminal of claim 24, wherein the elastic part press-held by the bent parts is covered by resin material.
